(19) United States
(12) Patent Application Publication
(10) Pub. No.: US 2008/0118377 A1
(43) Pub. Date: May 22, 2008

(54) Exhaust Gas Turbo Charger

(76) Inventors: Johannes Ante, Regensburg (DE); Markus Gilch, Mauern (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/663,135

(22) PCT Filed: Sep. 2, 2005
(86) PCT No.: PCT/EP05/54331

§ 371 Date: Mar. 16, 2007

(30) Foreign Application Priority Data
Sep. 7, 2004 (DE) 10 2004 0450618.6

(51) Int. Cl. F02B 39/00; F01D 25/00; G01P 3/48; G01P 3/66

(52) U.S. Cl. 417/407; 324/179

(57) ABSTRACT

Presented is an exhaust gas turbocharger. The turbocharger includes a compressor, a turbine, a compressor wheel mounted rotatably in the compressor, a rotatably mounted turboshaft, a device for detecting the rotational speed of the turboshaft, an element for varying a magnetic field, and a turbine wheel mounted rotatably in the turbine. The compressor wheel is mechanically connected to the turbine wheel via the turboshaft. The device for detecting the rotational speed includes the element for varying the magnetic field which is disposed on or in the turboshaft in the region between the compressor wheel and the turbine wheel. The variation of the magnetic field occurring as a function of the rotation of the turboshaft. The turbocharger further includes a sensor element, which detects the variation of the magnetic field and converts it into signals which can be evaluated electrically, arranged in proximity to the element for varying the magnetic field.

The invention relates to an exhaust gas turbocharger for an internal combustion engine, comprising a compressor and a turbine, a compressor wheel being mounted rotatably in the compressor and a turbine wheel being mounted rotatably in the turbine, the compressor wheel being mechanically connected to the turbine wheel by means of a rotatably mounted turboshaft and the exhaust gas turbocharger having a device for detecting the rotational speed of the turboshaft.

The power generated by an internal combustion engine depends on the air mass and the corresponding quantity of fuel which can be made available to the engine for combustion. If it is desired to increase the power of the internal combustion engine, more combustion air and more fuel must be supplied. In the case of a naturally aspirated engine this power increase can be achieved by enlarging the swept volume or by increasing the engine speed. However, enlargement of the swept volume leads in principle to heavier engines of larger dimensions and therefore higher cost. Increasing the engine speed entails considerable problems and disadvantages, especially with relatively large engines, and is limited for technical reasons.

A much-used technical solution for increasing the power of an internal combustion engine is pressure charging. This refers to precompression of the combustion air by an exhaust gas. turbocharger or by means of a compressor mechanically driven by the engine. An exhaust gas turbocharger consists essentially of a flow compressor and a turbine, which are connected to one another by a common shaft and rotate at the same speed. The turbine converts the otherwise uselessly escaping energy of the exhaust gas into rotational energy and drives the compressor. The compressor aspirates fresh air and conveys the pre-compressed air to the individual cylinders of the engine. An increased quantity of fuel can be supplied to the larger quantity of air in the cylinders, whereby the internal combustion engine delivers more power. In addition, the combustion process is influenced favorably, so that the engine achieves better overall efficiency. In addition, the torque curve of an internal combustion engine charged with a turbocharger can be configured extremely favorably. Existing naturally aspirated engines in series production can be significantly optimized by vehicle producers through the use of an exhaust gas turbocharger without major design interventions. Pressure-charged internal combustion engines generally have lower specific fuel consumption and have lower noxious emissions. Moreover, turbocharged engines are as a rule quieter then naturally aspirated engines of the same power, because the exhaust gas turbocharger itself acts like an additional silencer. In the case of internal combustion engines with a wide operating speed range, for example, engines for passenger cars, a high charge pressure is required even at low engine speeds. For this purpose a charge pressure control valve, called a waste-gate valve, is introduced in these turbochargers. Through the selection of an appropriate turbine housing a high charge pressure is quickly built up even at low engine speeds. The waste-gate valve then limits the charge pressure to a constant value as engine speed rises. Alternatively, turbochargers with variable turbine geometry (VTG) are used.

With an increasing quantity of exhaust gas the maximum permissible rotational speed of the combination comprising turbine wheel and turboshaft, also referred to as the rotor of the turbocharger, may be exceeded. Impermissible exceeding of the speed of the rotor would destroy the latter, which is equivalent to total loss of the turbocharger. In particular modern, small turbochargers with significantly smaller turbine and compressor diameters, which have improved rotational acceleration behavior through a considerably lower mass moment of inertia, are affected by the problem of exceeding the permissible maximum rotational speed. Depending on the design of the turbocharger, exceeding of the speed limit by approximately 5% causes complete destruction of the turbocharger.

Charge pressure control valves which, according to the prior art, are activated by a signal resulting from the charge pressure generated, have proved effective for limiting rotational speed. If the charge pressure exceeds a predetermined threshold value, the charge pressure control valve opens and conducts a part of the exhaust gas mass flow past the turbine. Because of the reduced mass flow, the turbine absorbs less power and the compressor output is reduced proportionally. The charge pressure and the rotational speed of the turbine wheel and the compressor wheel are reduced. However, this regulation is relatively sluggish, because the pressure build-up in the event of the rotor exceeding a given speed occurs with a time offset. For this reason regulation of turbocharger speed by monitoring charge pressure must be effected in the high dynamic range (load change) by correspondingly early reduction of charge pressure, incurring a loss of optimum efficiency.

Direct measurement of rotational speed on the compressor wheel or the turbine wheel is difficult to implement because the turbine wheel, for example, is subjected to extreme thermal load (up to 1000° C.), which prevents rotational speed measurement on the turbine wheel by conventional methods. In a publication of acam-Messelektronic GmbH of April 2001 it is proposed to measure the compressor blade pulses using the eddy current principle and in this way to determine the rotational speed of the compressor wheel. This method is complex and costly, since at least one eddy current sensor would have to be integrated in the compressor housing, which is likely to be extremely difficult because of the high precision with which turbocharger components are manufactured. In addition to the precise integration of the eddy current sensor in the compressor housing, sealing problems arise which, because of the high thermal stress of a turbocharger, can be overcome only with complex and costly interventions in the construction of the turbocharger.

It is therefore the object of the present invention to specify an exhaust gas turbocharger for an internal combustion engine in which the rotational speed of the rotating parts (turbine wheel, compressor wheel, turboshaft) can be detected simply, at low cost and without major interventions in the construction of existing turbochargers.

This object is achieved according to the invention in that the device for detecting the rotational speed has on and/or in the turboshaft in the region between the compressor wheel and the turbine wheel an element for varying a magnetic field, the variation of the magnetic field occurring as a function of the rotation of the turboshaft and a sensor element, which detects the variation of the magnetic field and converts it into signals which can be evaluated electrically, being arranged in proximity to the element for varying the magnetic field.

An advantage of arranging the element for varying the magnetic field on and/or in the turboshaft in the region between the compressor wheel and the turbine wheel is that this region of the turbocharger is subjected to relatively low thermal load because it is located at a distance from the hot exhaust gas flow and is generally cooled by oil lubrication. In addition, the region of the turboshaft between the compressor wheel and the turbine wheel is easily accessible, so that commercially available sensor elements, for example Hall sensor elements, magnetoresistive sensor elements or inductive sensor elements, can be placed here with only small interventions in the construction of existing turbochargers, making possible cost-effective speed measurement in or on the turbocharger. Using the signal generated by the sensor element, the charge pressure control valve can be activated, or the turbine geometry of VTG turbochargers can be changed, very quickly and precisely in order to avoid exceeding the rotational speed of the rotor. The turbocharger can therefore be operated very close to its speed limit, thus achieving its maximum efficiency. A relatively large safety margin from the maximum speed limit, as is usual with pressure-controlled turbochargers, is not required.

In a first development, the sensor element is in the form of a Hall sensor element. Hall sensor elements are very well suited to detecting variation of a magnetic field and can therefore be used very appropriately for detecting rotational speed. Hall sensor elements are very cost-effective.

Alternatively, the sensor element is in the form of a magnetoresistive (MR) sensor element. MR sensor elements are also well suited to detecting variation of a magnetic field, are commercially available at low cost and can be used at temperatures up to 270° C.

In a further alternative embodiment, the sensor element is in the form of an inductive sensor element. Inductive sensor elements are also very well suited to detecting variation of a magnetic field and can also be used at high temperatures.

According to an alternative embodiment, the sensor element can be placed on the outer wall of the turbocharger housing in the region between the compressor and the turbine. This embodiment requires no intervention in the turbocharger housing. A strong magnet, for example, which is arranged in the region of the turboshaft between the compressor wheel and the turbine wheel, generates a sufficiently large variation of the magnetic field in the sensor element arranged on the outer wall of the turbocharger as the turboshaft rotates, so that an electrical signal corresponding to the speed of the turboshaft can be generated in this sensor. For this purpose the housing of the turbocharger in this zone is made of a non-magnetically-shielding material.

In a further embodiment, the element for varying a magnetic field is in the form of a bar magnet. A diametrically polarized bar magnet rotating with the turboshaft generates in its environment an easily measurable variation of the magnetic field, whereby the speed of the turboshaft, the compressor and the turbine wheel can be effectively detected.

Alternatively, the element for varying a magnetic field is in the form of two magnetic dipoles, the north pole of the first dipole being oriented towards the south pole of the second dipole. Two magnetic dipoles perform the same function as a bar magnet but are lighter than a bar magnet, which is very advantageous.

In a further embodiment of the invention, the element for varying a magnetic field is in the form of a slot in the region of the turboshaft between the compressor wheel and the turbine wheel. With a slot in a ferromagnetic material, a magnetic field applied from outside can be varied in an effective manner. The magnetic flux is conducted according to the slotting which rotates in the field. This simple and cost-effective measure produces an easily measurable variation of the magnetic field in the sensor element.

Embodiments of the invention are illustrated in an exemplary manner in the figures, in which:

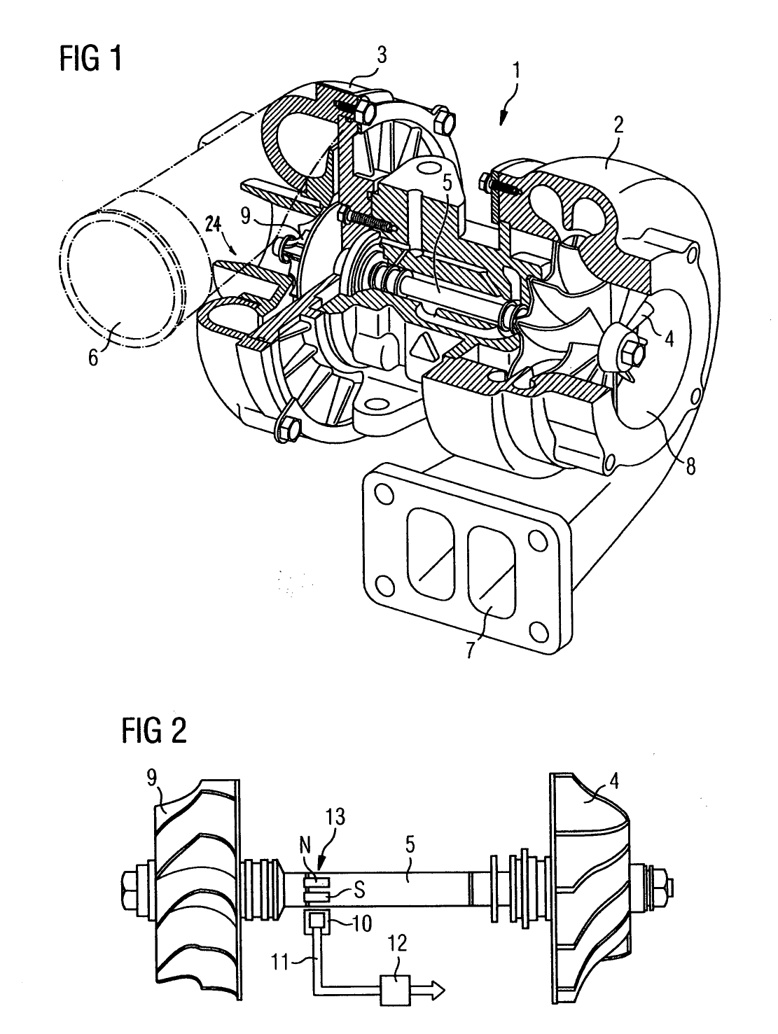

FIG. 1 shows an exhaust gas turbocharger,

FIG. 2 shows the turbine wheel, the turboshaft and the compressor wheel.

FIG. 1 shows an exhaust gas turbocharger 1 comprising a turbine 2 and a compressor 3. The compressor wheel 9 is mounted rotatably in the compressor 3 and is connected to the turboshaft 5. The turboshaft 5 is also mounted rotatably and is connected at its other end to the turbine wheel 4. Hot exhaust gas from an internal combustion engine (not shown) is admitted to the turbine 2 via the turbine inlet 7, the turbine wheel 4 being thereby set in rotation. The exhaust gas flow leaves the turbine 2 through the turbine outlet 8. The turbine wheel 4 is connected to the compressor wheel 9 via the turboshaft 5. The turbine 2 drives the compressor 3 thereby. Air is sucked into the compressor 3 through the air inlet 24 and is then compressed and delivered to the internal combustion engine via the air outlet 6.

FIG. 2 shows the turbine wheel 4, the turboshaft 5 and the compressor wheel 9. The turbine wheel 4 is generally made of a high-temperature-resistant austenitic nickel compound which is suitable even for the high temperatures occurring when the turbocharger is used to charge spark-ignition engines. It is produced using a precision casting method and is connected to the turboshaft 5, which generally consists of high-tempered steel, by, for example, friction welding. The component comprising turbine wheel 4 and turboshaft 5 is also referred to as the rotor. The compressor wheel 9 is made, for example, of an aluminum alloy, also by a precision casting method. The compressor wheel 9 is generally fixed by a fixing element to the compressor end of the turboshaft 5. This fixing element may be, for example, a cap nut which clamps the turbine wheel firmly against the turboshaft shoulder with a sealing bush, a bearing collar and a spacer bush. The rotor thus forms a rigid unit with the compressor wheel 9. Because the compressor wheel 9 is generally made of an aluminum alloy it is problematic to determine the speed of the compressor wheel at this location using a measuring method based on magnetic field change.

An element 13 for varying the magnetic field is formed on and/or in the turboshaft 5 in the region of the turboshaft 5 between the compressor wheel 9 and the turbine wheel 4. In this example the element 13 for varying the magnetic field is placed in or on the turboshaft 5 as a dipole magnet. The magnetic dipole has a north pole N and a south pole S. It is also possible to configure the element 13 as a higher-order magnetic multipole or as a change in the ferromagnetic material of the turboshaft 5. If the magnetic field is generated, for example, by a magnet arranged outside the turboshaft 5, a speed-dependent variation of the magnetic field can be generated in the sensor element 10 by a slot in the ferromagnetic material of the turboshaft 5.

The element 13 for varying the magnetic field moves with the turboshaft, whereby a speed-dependent variation of the magnetic field can be measured with the sensor element 10 arranged in proximity thereto. In this context a sensor element 10 is said to be arranged in proximity to the element 13 for varying the magnetic field if an easily measurable magnetic field variation which is sufficiently strong for speed measurement is generated in the sensor element 10 by the element 13 for varying the magnetic field.

As a major advantage of measuring the speed of the turboshaft 5 in the region of the turboshaft 5 between the compressor wheel 9 and the turbine wheel 4, the temperature prevailing in this region should be mentioned. Exhaust gas turbochargers 1 are thermally highly-stressed components in which temperatures up to 1000° C. occur. Measuring cannot be carried out at temperatures of approximately 1000° C. using known sensor elements 10, for example, Hall sensors or magnetoresistive sensors, since these sensors are destroyed thermally. Significantly lower temperature loads for the sensor elements occur in the region of the turboshaft 5 between the compressor wheel 9 and the turbine wheel 4 because this region is located away from the hot exhaust gas flow and as a rule is cooled by the oil lubrication of the turboshaft 5.

The electrical signals generated by the sensor element 10 are supplied via electric lines 11 to an electronic evaluation unit 12 which then activates, for example, the waste-gate valve (not shown) or the variable turbine blades.

1.-8. (canceled)

9. An exhaust gas turbocharger for an internal combustion engine, comprising:
a turbocharger housing defining a compressor and a turbine;
a compressor wheel rotatably mounted in said compressor;
a turbine wheel rotatably mounted in said turbine;
a turboshaft mechanically connecting said compressor wheel to said turbine wheel such that said compressor wheel rotates with said turbine wheel;
a device for detecting the rotational speed of the turboshaft comprising an element for varying a magnetic field as a function of the rotation speed of the turboshaft, said element being disposed on or in said turboshaft in a region between the compressor wheel and the turbine wheel; and
a sensor element configured to detect the variation of the magnetic field and convert the variation of the magnetic field into electrically evaluatable signals, said sensor element being arranged proximate said element for varying the magnetic field.

10. The exhaust gas turbocharger of claim 1, wherein the sensor element is a Hall sensor element.

11. The exhaust gas turbocharger of claim 1, wherein the sensor element is a magnetoresistive sensor element.

12. The exhaust gas turbocharger of claim 1, wherein the sensor element is an inductive sensor element.

13. The exhaust gas turbocharger of claim 1, wherein the sensor element is arranged on an outer wall of said turbocharger housing in the region between the turbine and the compressor.

14. The exhaust gas turbocharger of claim 1, wherein said element for varying a magnetic field is a bar magnet.

15. The exhaust gas turbocharger of claim 1, wherein the element for varying a magnetic field includes two magnetic dipoles, a north pole (N) of the first dipole being oriented towards a south pole (S) of the second dipole.

16. The exhaust gas turbocharger of claim 1, wherein the element for varying a magnetic field includes a slot in the region of the turboshaft between the compressor wheel and the turbine wheel.
